(19) United States
(12) Patent Application Publication
(10) Pub. No.: US 2023/0082970 A1
(43) Pub. Date: Mar. 16, 2023

(54) FOAMED GLASS AGGREGATE-CONTAINING CEMENTITIOUS BLOCKS

(71) Applicant: Aero Aggregates of North America LLC, Eddystone, PA (US)

(72) Inventors: Archibald Stewart Filshill, Huntingdon Valley, PA (US); Thomas Liam McGrath, Huntingdon Valley, PA (US)

(73) Assignee: Aero Aggregates of North America LLC, Eddystone, PA (US)

(21) Appl. No.: 17/800,831

(22) PCT Filed: Feb. 19, 2021
(86) PCT No.: PCT/US2021/018797

§ 371 Date: Aug. 18, 2022

Related U.S. Application Data
(60) Provisional application No. 62/979,623, filed on Feb. 21, 2020.

(51) Int. Cl. B28B 23/00; C04B 28/04; C04B 20/00; C04B 40/00

(52) U.S. Cl. CPC B28B 23/0087; C04B 28/04; C04B 20/004; C04B 40/0067

(57) ABSTRACT

Systems and methods are disclosed for producing a shaped cementitious article comprising mixing foamed glass aggregate particles, Portland cement, and water, placing the mixture into a mold, applying vibration and/or pressure to the mold, removing the mold, and then curing the molded concrete article. The shaped cementitious article may be a concrete block (e.g., a solid block, a hollow block, a flue, a curb, or a paver). The concrete block may be a relatively lightweight formed concrete block defining a hollow interior portion (e.g., “cinder block” shaped).

### CROSS REFERENCE TO RELATED APPLICATION

This application claims priority to U.S. Provisional Ser. No. 62/979,623 filed Feb. 21, 2020, the entire disclosure of which is incorporated by reference herein.

### BACKGROUND

Foamed glass aggregates (also sometimes known as foam glass aggregates) are made from recycled glass that is cleaned, ground, mixed with a foaming agent, heated, and allowed to fragment from temperature shock. Foamed glass aggregates are understood to be loose particles or fragments, in contrast to shaped articles made of foamed glass (e.g., such as blocks). As used in this disclosure, foamed glass aggregates and foamed glass aggregate particles are used interchangeably, the latter merely to reiterate the nature of the material.

Foamed glass aggregates may be used for applications in the soil, such as, for example, fill (e.g., lightweight fill for construction applications, landfill cover, building insulation, coastal resiliency amelioration, etc.). Foamed glass aggregates may also be incorporated into vehicle arrestor beds.

Foamed glass aggregates have also been used to make lightweight concrete. However, drying times are typically on the order of days, and require at least 12 hours in a form or mold before removal. This is known as a “wet-cast” process.

Concrete block making machines, such as those available from Form Impianti S.R.L., do not use wet-cast concrete as described above, but rather use a cementitious mixture known as zero-slump, no-slump, dry-pack, dry-cast, or vibrant dry tamp concrete mix. The disclosure will use the term “dry-cast” to refer to all such mixtures. Much lower water content (e.g., as compared to wet-cast), combined with vibration equipment with frequencies varying from approximately 3,000 to 16,000 vibrations per minute, allow shaped cementitious articles to be pressed into shape and removed from the form within seconds. The shaped cementitious articles are then cured (e.g., outside of the form). In the past, relatively lightweight dry-cast concrete mixes have been achieved with expanded shale, expanded slate, or expanded clay. However, since foamed glass aggregates provide an important economic driver for glass recycling, finding new uses and applications for foamed glass aggregates is extremely desirable.

Thus, what is needed are improved systems and methods for a dry-cast concrete mixture containing foamed glass aggregates.

### SUMMARY

Systems and methods are disclosed for producing a shaped cementitious article comprising mixing foamed glass aggregate particles, Portland cement, and water, placing the mixture into a mold, applying vibration and/or pressure to the mold, removing the mold, and then curing the molded concrete article. The shaped cementitious article may be a concrete block (e.g., a solid block, a hollow block, a flue, a curb, or a paver).

Systems and methods are disclosed for forming a concrete block, wherein the method comprises replacing a portion of conventional aggregate (e.g., that would typically be used for forming the block) with foamed glass aggregate particles. In some embodiments, the method comprises replacing about 20% by weight to about 100% by weight of the conventional aggregate with foamed glass aggregate particles. The concrete block may be a relatively lightweight formed concrete block defining a hollow interior portion (e.g., “cinder block” shaped). In an example, the foamed glass aggregate particles may have a diameter of about 10 mm or less.

### DETAILED DESCRIPTION

Systems and methods are disclosed for producing a shaped cementitious article comprising mixing foamed glass aggregate particles, Portland cement, and water, placing the mixture into a mold, applying vibration and/or pressure to the mold, removing the mold, and then curing the molded concrete article. The shaped cementitious article may be a concrete block (e.g., a solid block, a hollow block, a flue, a curb, or a paver). Systems and methods are also disclosed for forming a concrete block, wherein the method comprises replacing a portion of conventional aggregate (e.g., that would typically be used for forming the block) with foamed glass aggregate particles.

Foam glass aggregates are an inert, stable, and environmentally friendly substrate. Typically, to form foam glass aggregates, recycled glass is cleaned, ground, mixed with a foaming agent, heated, and allowed to fragment from temperature shock. The resulting aggregates are cellular, with a relatively low bulk density, but relatively high durability. Since foam glass aggregates provide an important economic driver for glass recycling, finding new uses and applications for foam glass aggregates is extremely desirable.

The foam glass aggregates are preferably ultra-lightweight foamed glass aggregates, and more preferably, UL-FGA™ foamed glass aggregates procured from AERO AGGREGATES, Eddystone, Pa. The foam glass aggregates may be prepared from a recycled glass cullet. The foam glass aggregates may be prepared from a sodo-calic glass. As foam glass aggregates are made up of silica, it may be considered a natural material for regulatory purposes. As foam glass aggregates are made from recycled glass (for example, post-consumer recycled glass), it may be considered environmentally friendly. Alternatively, foam glass aggregates may be prepared from waste glass (e.g., byproduct from glass manufacture) or other glass particles, for example, glass that is other than post-consumer recycled glass. As noted above, foam glass aggregates properties include low unit weight, low thermal conductivity, high strength, non-absorbency, and non-toxicity. As noted above, foam glass aggregates are non-leachable, chemically stable, impervious to UV degradation, freeze/thaw stable, and fireproof.

In a first example, the foamed glass aggregates may have an open cell structure. Open cell foamed glass is produced by using a different foaming agent than that used for closed cell foamed glass. The foaming agent for open cell reacts faster in the heating process and creates inter-connections between the air bubbles. The foamed glass aggregates with an open cell structure may, in particular, have a plurality of open pores.

In a second example, the foamed glass aggregates may have a closed cell structure. In some embodiments, closed cell foamed glass aggregate particles are preferred. For example, closed cell foamed glass aggregate particles may exhibit less porosity and be more desirable for construction applications.

It is understood that foamed glass aggregates, as used in this disclosure, comprises both open cell foamed glass aggregate particles or closed cell foamed glass aggregate particles unless specified as one or the other.

In an embodiment, a dry-cast concrete mixture comprising foam glass aggregate particles, Portland cement, and water is described. Dry-cast is meant, as used herein, to refer to a concrete mix that is used in a vibratory process that involves not curing in a mold.

A suitable proportion of foam glass aggregates to Portland cement for the dry-cast concrete mixture is dependent on the particular equipment system be used, but may be found by routine testing. Typically, the ratio of proportions vary in a range, inclusively (e.g., a:b with all intermediate ranges and values possible) from a) about 5 parts foam glass aggregates to about 1 part Portland cement to b) about 9 parts foam glass aggregates to about 1 part Portland cement. Preferably, the ratio of proportions varies is in a range from about 6 parts foam glass aggregates to about 1 part Portland cement to about 8 parts foam glass aggregates to about 1 part Portland cement.

A suitable proportion of water to Portland cement for the dry-cast concrete mixture may also be found by routine testing, but typically the ratio of proportions varies is in a range from about 0.25 parts water to about 1 part Portland cement to about 0.75 parts water to about 1 part Portland cement, preferably about 0.5 parts water to about 1 part Portland cement.

The foam glass aggregates may be ground (or crushed) and particles having a diameter in a range from 0 mm to 10 mm (e.g., all particles 10 mm or smaller) used in the dry-cast concrete mixture, such as by sieving. In an example, the dry-cast concrete mixture may have a Portland cement content of about 11% by weight to about 13% by weight, preferably 12% by weight.

The dry-cast concrete mixture may optionally include one or more of sand, ash, crushed stone, expanded shale, expanded slate, or expanded clay. In another example, the dry-cast concrete mixture may optionally include glass powder.

The dry-cast concrete mixture may optionally include additional binders, for example, polyethylene and/or polyurethane.

The dry-cast concrete mixture as described herein may be used to form a concrete block. As used herein, “concrete block” is intended to embrace any article produced from a mixture of foam glass aggregate particles of about 0 mm to about 10 mm in diameter, Portland cement, and water, provided that the concrete block is made in a vibratory process that involves not curing the concrete block in a mold. Examples of contemplated concrete blocks include concrete masonry units, solid blocks, hollow blocks (e.g., cinder blocks), flues, curbs, pavers, etc. Such foam glass aggregate particles-containing concrete block is one or more of relatively lighter, a better insulator, a better acoustic dampener, and/or more fire resistant. Benefits of foam glass aggregate particles-containing concrete block include lower shipping costs (e.g., due to the relatively lighter weight) and/or lower labor costs/higher productivity for installation (e.g., due to the relatively lighter weight).

Certain foam glass aggregates properties are particularly beneficial when used to make building materials, for example, dry-cast concrete blocks. For example, foam glass aggregates are highly frictional (e.g., once compacted, foam glass aggregates are unlikely to shift with time), foam glass aggregates are non-leaching, foam glass aggregates are chemically inert (e.g., safe and/or nonreactive), foam glass aggregates are rot-resistant (in fact, foam glass aggregates are rot proof), foam glass aggregates are non-flammable, foam glass aggregates are durable (e.g., foam glass aggregates does not degrade when used in this application), and foam glass aggregates are rodent and insect resistant. Moreover, dry-cast concrete blocks containing foam glass aggregate particles exhibit increased fire resistance, insulating properties, and noise absorption, as well as meeting LEED requirements as a green building material.

In an embodiment, a method for forming a concrete block is provided, wherein the method comprises replacing a portion of conventional aggregate (e.g., that would typically be used to make the concrete block) with foam glass aggregate particles. Examples of conventional aggregates include one or more of sand, ash, crushed stone, expanded shale, expanded slate, and/or expanded clay.

In an example, the foam glass aggregate particles may be about 0 mm to about 10 mm in diameter. The amount of foam glass aggregates needed to replace the conventional aggregate may be determined by volume, since, for example, a pound-for-pound replacement of conventional aggregate with foam glass aggregates would lead to too much material (e.g., foam glass aggregates are considerably lighter than conventional aggregate). In some embodiments, the method comprises replacing about 20% by weight to about 100% by weight of the conventional aggregate with foam glass aggregate particles. In an example, the concrete block is a relatively lightweight formed concrete block defining a hollow interior portion (e.g., “cinder block” shaped). In another example, the concrete block is a 12″×12″×2″ solid block. Such foam glass aggregate particles-containing blocks may exhibit lighter weight than conventional blocks. Advantageously, a mixed block containing both conventional aggregates and foam glass aggregate particles may exhibit light weight (as compared to conventional blocks) and greater strength (as compared to blocks containing no conventional aggregates).

In an embodiment, a method for forming a concrete block (e.g., a relatively lightweight formed concrete block defining a hollow interior portion) is provided, wherein the method comprises mixing foam glass aggregate particles of about 0 mm to about 10 mm in diameter, Portland cement, and sufficient water to make it pourable into the molds (e.g., a dry-cast concrete mixture), placing the mixture into a mold, applying vibration and optionally pressure to the mixture, removing the mold, and then curing the molded concrete block. In an example, a dry-cast concrete mixture is placed into a Form Impianti Series Fi 100 concrete block making machine, available from Form Impianti S.R.L, and formed into a concrete block. The concrete block is removed from the concrete block making machine and cured. The curing may take place in a chamber with one or more of increased temperature, increased pressure, and/or increased humidity (e.g., steam).

### EXAMPLES

### Example 1

Recycled glass cullet is cleaned, ground to less than 150 micrometers (US Standard sieve size No. 100), mixed with a foaming agent (e.g., for open cell foam glass aggregate particles, a carbonate foaming agent; for closed cell foam glass aggregate particles, a silicon carbide foaming agent) in a blending unit, heated, and allowed to fragment from temperature shock. The resulting foam glass aggregates are cellular.

### Example 2

Recycled glass cullet is cleaned, ground, mixed with a foaming agent, heated, and allowed to fragment from temperature shock. The resulting foam glass aggregates are cellular (foaming creates a thin wall of glass around each gas bubble). By volume, foam glass aggregates are approximately 92% gas bubbles and 8% glass.

### Example 3

Foam glass aggregate particles, such as may be obtained in Examples 1 or 2 are ground (or crushed) to produce foam glass aggregate particles of about 0 mm to about 10 mm in diameter. The foam glass aggregate particles are combined with Portland cement and sufficient water to make a pourable dry-cast concrete mixture. The dry-cast concrete mixture is placed into a Form Impianti Series Fi 100 concrete block making machine, available from Form Impianti S.R.L, and formed into a concrete block. The concrete block is removed from the concrete block making machine and then cured (e.g., outside of a mold).

1. A method for producing a shaped cementitious article comprising:
mixing foamed glass aggregate particles, Portland cement, and water;
placing the mixture into a mold;
applying vibration to the mold;
removing the mold; and
then curing the molded concrete article.

2. The method of claim 1, wherein the foamed glass aggregate particles are closed cell foamed glass aggregate particles.

3. The method of claim 1, wherein the foamed glass aggregate particles are open cell foamed glass aggregate particles.

4. The method of claim 1, wherein the proportion of foamed glass aggregate particles to Portland cement is in a range from about 5 parts foamed glass aggregate particles:about 1 part Portland cement to about 9 parts foamed glass aggregate particles:about 1 part Portland cement.

5. The method of claim 1, wherein the proportion of foamed glass aggregate particles to Portland cement is in a range from about 6 parts foamed glass aggregate particles:about 1 part Portland cement to about 8 parts foamed glass aggregate particles:about 1 part Portland cement.

6. The method of claim 1, wherein the proportion of water to Portland cement is in a range from about 0.25 parts water to about 1 part Portland cement to about 0.75 parts water to about 1 part Portland cement.

7. The method of claim 1, wherein the proportion of water to Portland cement is in a range from about 0.5 parts water to about 1 part Portland cement.

8. The method of claim 1, further comprising grinding the foamed glass aggregate particles to have a diameter in a range from about 0 mm to about 10 mm in diameter.

9. The method of claim 1, wherein the mixture has a Portland cement content of about 11% by weight to about 13% by weight.

10. The method of claim 1, further comprising mixing one or more of sand, crushed stone, expanded shale, expanded slate, or expanded clay with the foamed glass aggregate particles, Portland cement, and water.

11. The method of claim 1, wherein the mixture further comprises glass powder.

12. The method of claim 1, wherein the mixture further comprises polyethylene and/or polyurethane as a binder.

13. The method of claim 1, wherein the shaped cementitious article is a concrete block that is a solid block, a hollow block, a flue, a curb, or a paver.

14. The method of claim 1, wherein the shaped cementitious article is a lightweight formed concrete block defining a hollow interior portion.

15. A method of forming a concrete block, comprising,
using foamed glass aggregate particles to replace at least greater than 10% of aggregate, wherein the aggregate is one or more of sand, ash, crushed stone, expanded shale, expanded slate, or expanded clay, to create a foamed glass aggregate particles containing mixture;
placing the foamed glass aggregate particles containing mixture into a concrete block making machine;
forming a concrete block from the foamed glass aggregate particles containing mixture, wherein the concrete block is made in a vibratory process; and
curing the concrete block, provided that the concrete block is not cured in a mold.

16. (canceled)

17. The method of claim 15, wherein the foamed glass aggregate particles are closed cell foamed glass aggregate particles.

18. The method of claim 15, wherein the foamed glass aggregate particles are open cell foamed glass aggregate particles.

19. The method of claim 15, wherein foamed glass aggregate particles have a diameter in a range from about 0 mm to about 10 mm in diameter.

20.-21. (canceled)

22. The method of claim 15, wherein the concrete block is removed from the concrete block making machine and cured.

23. The method of claim 22, further comprising curing the concrete block in a chamber with one or more of increased temperature, increased pressure, and/or increased humidity.

24.-36. (canceled)
